(19) United States
(12) Patent Application Publication
(10) Pub. No.: US 2024/0263617 A1
(43) Pub. Date: Aug. 8, 2024

(54) STABILIZED WIND TURBINES, SYSTEMS FOR STABILIZING WIND TURBINES, AND METHODS FOR INSTALLING SAME

(71) Applicant: Vestas Wind Systems A/S, Aarhus N (DK)

(72) Inventors: Jens-Jørgen Hansen, Højberg (DK); Torben Ladegaard Baun, Skødstrup (DK); Jesper Lykkegaard Neubauer, Hornslet (DK); Christian Skov, Videbæk (DK)

(21) Appl. No.: 18/567,902

(22) PCT Filed: Jun. 24, 2022
(86) PCT No.: PCT/DK2022/050143

§ 371 Date: Dec. 7, 2023

(30) Foreign Application Priority Data
Jun. 30, 2021 (DK) PA202170338

(51) Int. Cl. F03D 13/20

(52) U.S. Cl. CPC F03D 13/201; F05B 2240/912; F05B 2240/917

(57) ABSTRACT

A wind turbine (10) supported by a plurality of cables (20). The wind turbine (10) includes a tower (12) fixed at one end to a foundation (16) and including at least two tower sections (12a, 12b, 12c), including an upper section and a lower section. Each of the upper and lower sections includes an inwardly directed flange (82, 90) having a plurality of through-bores (84, 92). The inwardly directed flange (90) of the lower section further includes a plurality of second bores (104) spaced apart from the plurality of through-bores (92). An interface module (18, 120) is secured between the upper and lower section and includes a ring (62) from which one or more cars (50, 204) extend outwardly, each ear (50, 204) being configured to be coupled to one of the plurality of cables (20). The ring (62) includes a plurality of through-bores (72) that align with the through-bores (84, 92) in the inwardly directed flanges (82, 90) of each of the upper and lower tower sections and a plurality of additional bores (96) that align with the plurality of second bores (104) in the inwardly directed flange (90) of the lower section. A method of installing a wind turbine (10) having a cabled tower (12) is also disclosed.

### TECHNICAL FIELD

The invention relates generally to wind turbines, and more particularly to a system for stabilizing a wind turbine and to a method for installing the system.

### BACKGROUND

Wind turbines are used to produce electrical energy using a renewable resource and without combusting a fossil fuel. Generally, a wind turbine converts kinetic energy from the wind into electrical power. A horizontal-axis wind turbine includes a tower and an energy generating unit positioned atop of the tower. The energy generating unit typically includes a nacelle to house mechanical and electrical components, such as a generator, and a rotor operatively coupled to the components in the nacelle through a main shaft extending from the nacelle. The rotor, in turn, includes a central hub and a plurality of blades extending radially therefrom and configured to interact with the wind to cause rotation of the rotor. The rotor is supported on the main shaft, which is either directly or indirectly operatively coupled with the generator housed inside the nacelle. Consequently, as wind forces the blades to rotate, electrical energy is produced by the generator.

The tower elevates the energy generating unit above the earth and is typically a tubular steel structure. A base end of the tower is fixed to a concrete foundation, and the energy generating unit is coupled to an opposing end of the tower. The tower must have a bearing capacity capable of supporting its own weight, the weight of the energy generating unit, and dynamic loads during operation of the wind turbine. Transportation and/or production restrictions limit the tower size and thus bearing capacity. Yet, increasing the bearing capacity of the tower is desirable to increase the electrical generating capacity of the wind turbine.

To increase the bearing capacity of the tower, the diameter of the tower may be increased.

Increasing the diameter of the tower increases the bearing capacity by the power of two. That is, doubling the diameter of the tower quadruples the bearing capacity of the tower.

Advantageously, tower stiffness also increases but by a power of three. So, increasing the diameter permits larger, more powerful energy generating units to be utilized. While increasing the diameter is effective, there is an upper limit to the diameter of the tower. As identified above, production and/or transportation limit increases in diameter and increases in height of the tower. Another dimension that may be modified is the shell thickness or wall thickness.

While the shell thickness may be increased, it is generally an inefficient way of increasing the bearing capacity and the stiffness as compared to increasing the tower diameter. Bearing capacity and stiffness increase only linearly with the shell thickness. With transportation and/or production being a limiting factor for increasing bearing capacity, other solutions have been developed.

To address transportation and production limitations, some towers are composed of multiple tower sections coupled end-to-end at joints. A tower may be composed of two or more sections joined end-to-end. Even according to this solution, the diameter of each section is limited by transportation and/or production because of the overall dimensions of the sections or because of the weight of each tower section.

As an alternative or in addition to changing the dimensions of the tower, bearing capacity of a tower can be increased and the stresses in parts of the tower reduced by stabilizing the tower with cables or wires. The cables extend from anchors or foundations in the earth to points on the tower. The cables are tensioned and so improve stability by reducing tower oscillations produced by the wind. With this so-called guyed tower or tethered tower, certain loads are carried by the cables and so are not carried by the tower. Each tower section may therefore be constructed with a relatively smaller diameter, which is more economical to produce and/or transport, while also obtaining a predetermined tower height.

One drawback to a tethered tower is that it takes up more land. Land consumption must be accounted for during planning and especially during erection and maintenance of the wind turbine. Also, proper tensioning and attachment of the cables are crucial for the wind tower to withstand the varying and potentially large wind forces.

The wind turbine industry is searching for solutions to installation and attachment of cables at minimal cost while stabilizing wind turbine towers during energy production.

### SUMMARY

To these and other ends, stabilized wind turbines, systems for stabilizing wind turbines, and methods of installing a stabilization system for wind turbines are provided. A stabilized wind turbine is supported by a plurality of cables.

In one embodiment, the wind turbine includes a tower fixed at one end to a foundation and providing an apex at an opposing end. The tower includes at least two tower sections, including an upper section and a lower section. Each of the upper and lower sections includes an inwardly directed flange having a plurality of through-bores. The inwardly directed flange of the lower section further includes a plurality of second through-bores spaced apart from the plurality of through-bores. An interface module is secured between the upper and lower sections. The interface module includes a ring from which one or more ears extend outwardly. Each ear is configured to be coupled to one of the plurality of cables. The ring includes a plurality of through-bores that align with the through-bores in the inwardly directed flanges of each of the upper and lower tower sections. The ring also includes a plurality of additional bores that align with the plurality of second through-bores in the inwardly directed flange of the lower section.

An energy generating unit is disposed at the apex of the tower and is configured to produce electrical energy from wind.

In one embodiment, the plurality of through-bores in the ring are arranged on a first radius from a center of the ring. The plurality of additional bores is arranged on a second radius from the center. The second radius is larger or smaller than the first radius. The plurality of additional bores includes at least two additional bores proximate each ear.

In one embodiment, the ring may be non-segmented or may be segmented. When segmented, the ring may consist of three segments. Each segment including at least two ears where each segment is coupled to other segments at a joint at each end. Each segment may be identical.

In one embodiment, the joints are half-lap joints. Each joint is formed by a half-thickness member on each of the segments, and a joint interface between the opposing half-thickness members is oriented in a plane perpendicular to a vertical tower axis.

In one embodiment, the upper and lower tower sections include a wall from which each inwardly directed flange extend. Each ear extends outwardly and downwardly from the ring so that a neutral axis of the ear intersects a neutral axis of the ring at a neutral axis of each of the walls.

In one embodiment, each cable may be coupled to a respective ear at a cardan-type joint. The cardan-type joint may include an eyelet having a stop, and a socket on the cable may have a stop that cooperates with the stop on the eyelet to prevent rotation of the socket beyond a predetermined distance toward the foundation.

In one embodiment, each ear includes a pair of spaced-apart flanges. The ring further includes a stop positioned between the flanges. A flexible arm is coupled to the ear between the flanges and includes a stop that is configured to contact the stop on the ring. Collective contact between the two stops limits rotational movement of the flexible arm when the flexible arm rotates toward the foundation. Each cable is coupled to a respective ear at a joint. The joint includes two rotational axes. Two rotational axes are spaced apart by the flexible arm and are each oriented in a plane parallel to one another while being perpendicular to a vertical tower axis.

Further, in one embodiment, the flexible arm includes a through-slot.

In one embodiment, the wind turbine includes a tower fixed at one end to a foundation and providing an apex at an opposing end. The tower includes at least two tower sections, including an upper section and a lower section. The upper and lower sections each include a wall from which an inwardly directed flange extends. Each section includes an inwardly directed flange having a plurality of through-bores. An interface module is secured between the upper and lower sections. The interface module includes a ring from which one or more ears extend outwardly. Each ear is configured to be coupled to one of the plurality of cables. The ring includes a plurality of through-bores that align with the through-bores in the inwardly directed flanges of each of the upper and lower tower sections. Each ear extends outwardly and downwardly from the ring so that a neutral axis of the ear intersects a neutral axis of the ring at a neutral axis of each of the walls. An energy generating unit is disposed at the apex of the tower and is configured to produce electrical energy from wind.

In one embodiment, the flange on the lower section includes a plurality of second through-bores that are spaced apart from the plurality of through-bores. The interface module includes a plurality of additional bores that align with the second through-bores in the inwardly directed flange.

According to one aspect of the invention, there is a method of installing a wind turbine including an energy generating unit and a wind turbine tower that is coupled to a plurality of cables. The method includes installing the wind turbine tower including installing a first tower section on one ore more previously installed tower sections or on a foundation. The method further includes installing an interface module on the first tower section. The interface module includes a ring and a plurality of ears extending outwardly from the ring. Each ear is configured to be coupled to one of the plurality of cables. Attaching the interface module to the first tower section may further include tensioning each cable between one of the plurality of ears and an anchor and then installing the energy generating unit at an apex of the wind turbine tower.

In one embodiment, the first tower section includes a wall and a flange that extends inwardly from the wall. The flange includes a plurality of through-bores and a plurality of second through-bores. The ring includes a plurality of through-bores configured to align with the through-bores of the flange and also includes a plurality of bores configured to align with the second through-bores of the flange. Attaching the interface module to the tower section includes coupling the interface module to the flange via fasteners in the bores in the ring and the second through-bores in the flange. The method further includes installing a second tower section on the interface module and installing an energy generating unit.

In one embodiment, the second tower section includes a wall and a flange that extends inwardly from the wall. The second tower flange including a plurality of through-bores and wherein installing the second tower section includes aligning the through-bores of the second tower flange with the through-bores of each of the interface module and the first tower flange and inserting fasteners through the aligned through-bores of each of the first tower section, the interface module, and the second tower section.

In one embodiment, tensioning includes pre-tensioning each one of the plurality of cables to at least 70% of full tension. Tensioning may further include pre-tensioning each one of the plurality of cables to a tension in a range of 30% to 70% of full tension. Final tensioning of the cable to 100% of full tension may occur following installation of the second tower section or following installation of the energy generating unit.

In one embodiment, prior to installing the interface module, the method further includes attaching one or more of the plurality of cables to one or more of the plurality of ears. Installing the interface module may include separating the attached cables to create an opening sized to allow a diameter dimension of the first tower section and any previously installed tower section to pass through the opening.

Further, in one embodiment, the method includes elevating the interface module no more than a height that is within one-half meter of the height of the flange of the first tower section.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a wind turbine having a guyed tower according to one embodiment of the invention;

FIG. 2 is an enlarged perspective view of the encircled area 2 in FIG. 1;

FIGS. 3A and 3B are a perspective view and a plan view, respectively, of an interface module shown in FIG. 2 according to one embodiment of the invention;

FIG. 4 is a cross-sectional view of the tower of FIG. 2 taken along section 4-4;

FIG. 5 is a perspective view of a tower section with the interface module of FIGS. 3A and 3B secured thereto according to one embodiment of the invention;

FIG. 6A is a cross-sectional view taken along section 6A-6A of FIG. 5;

FIG. 6B is a cross-sectional view taken along section 6B-6B of FIG. 5;

FIG. 7 is an exploded view of one embodiment of an interface module;

FIG. 8 is an enlarged view of the encircled area 8 in FIG. 7;

FIG. 9 is an enlarged view of the encircled area 2 in FIG. 1 depicting one embodiment of an interface module;

FIG. 10 is an elevation view of installation of an interface module on to a tower section;

FIG. 10A is an enlarged view of a stress relief mechanism utilized during installation of an interface module according to one embodiment;

FIG. 11 is a plan view of the installation shown in FIG. 10; and

FIG. 12 is a cross sectional view of the interface module shown in FIG. 9.

### DETAILED DESCRIPTION

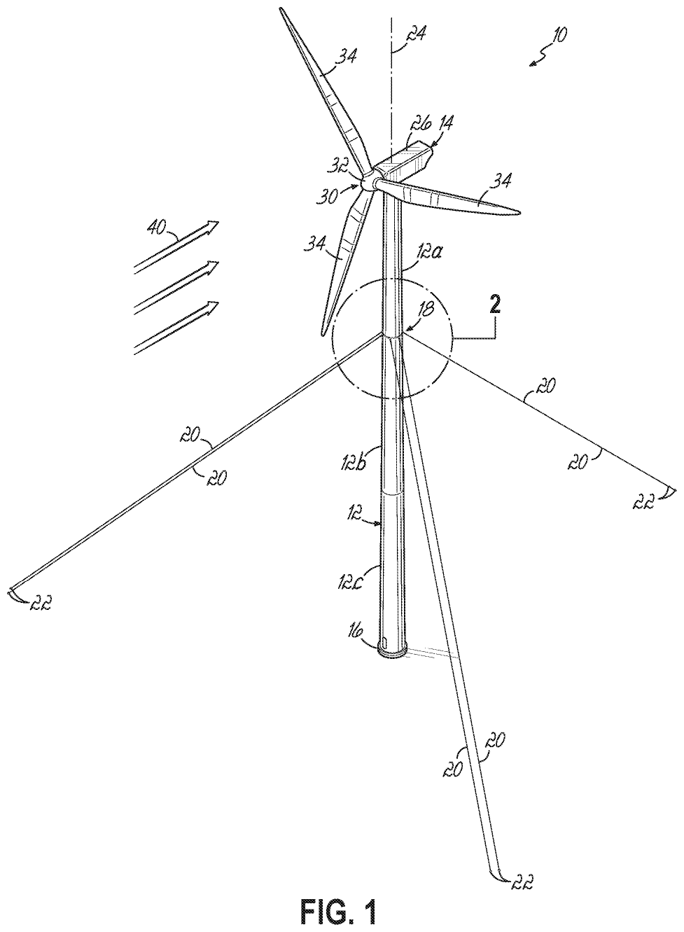

With reference to FIG. 1, a wind turbine 10 includes a tower 12 and an energy generating unit 14 disposed at the apex of the tower 12. The tower 12 may be coupled to a foundation 16 at a lower end thereof. The exemplary tower 12 shown is modular and includes three sections 12a, 12b, and 12c. As shown, by way of example only, an interface module 18 (described in detail below) is positioned between section 12a and section 12b and serves as a point of attachment for cables 20 to the tower 12. The cables 20 are secured to anchors 22 in the earth. The tower 12 is a so-called guyed tower. The interface module 18 in combination with cables 20 and anchors 22 are an effective stabilization system for the wind turbine 10. The three sections 12a, 12b, 12c, and interface module 18 collectively define a generally vertical tower axis 24 about which the energy generating unit 14 may rotate via a yaw mechanism (not shown). The foundation 16 may be a relatively large mass (e.g., concrete, anchor cage, etc.) embedded in the ground and through which forces on the wind turbine 10 may be ultimately transferred.

Although not shown, in an alternative embodiment, the foundation 16 may include an offshore platform or the like used in offshore wind turbine applications. The anchors 22 may be a portion of the foundation 16 or be separate anchor structures from the foundation 16. These anchors 22 may be in a symmetric circular array around the tower 12 or other pattern, such as one that enhances load carrying capacity in one direction. The guyed tower 12 supports the weight of the energy generating unit 14 and operates to elevate the energy generating unit 14 to a height above ground level or sea level at which faster moving air currents of lower turbulence are typically found.

In that regard, the energy generating unit 14 transforms the energy of the wind into electrical energy. The energy generating unit 14 typically includes a housing or nacelle 26, a rotor 30 having a central hub 32 and one or more blades 34 (e.g., three blades) mounted to the central hub 32 and extending radially therefrom, and a generator (not shown) for converting mechanical energy into electrical energy. The energy generating unit 14 may further include a drive train (not shown), including a gear arrangement, interconnecting the rotor 30 and the generator. The generator and a substantial portion of the drive train may be positioned inside of the nacelle 26 of the wind turbine 10. In addition to the generator, the nacelle 26 typically houses miscellaneous components required for converting wind energy into electrical energy and various components needed to operate, control, and optimize the performance of the wind turbine 10. The wind turbine blades 34 are configured to interact with the wind. As is shown in FIG. 1, wind 40 (shown as arrows) produces lift and causes the rotor 30 to spin or rotate generally within a plane defined by the wind turbine blades 34. The energy generating unit 14 generates power from the airflow 40 that passes through the swept area of the rotor 30. In addition to generating power, the airflow 40 produces dynamic loads on the wind turbine 10.

The dynamic loads and the static loads from the dead weight of the energy generating unit 14 must be borne by the tower 12 as supported by the cables 20.

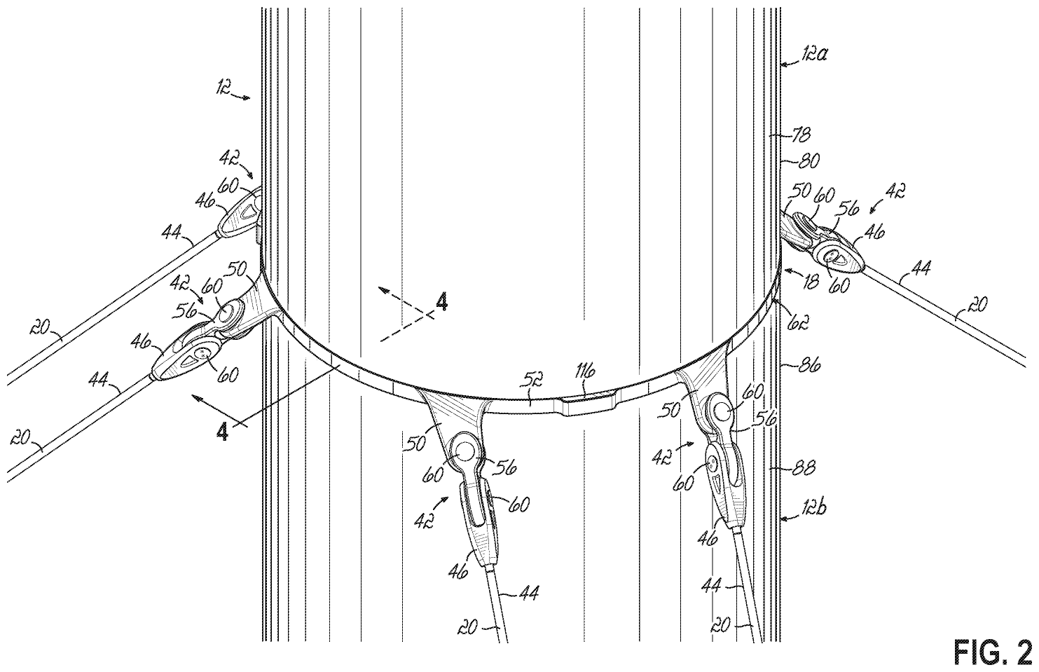

To that end, with reference now to FIG. 2, the interface module 18 is secured between the tower section 12a and the tower section 12b and is coupled to the cables 20. The interface module 18 shares some of the loads on the tower 12 during operation of the wind turbine 10. For instance, the interface module 18 distributes at least a portion of the dynamic loads from movement of the tower 12 due to the wind 40 to the cables 20. The offloading of those loads from the tower 12 to the cables 20 is advantageous. As an example, the tower may be redesigned with the diameter of the tower being reduced as compared to a tower without cables.

Other changes are also possible and may include increasing the height of the tower and/or placing a larger rotor/more powerful energy generating unit on the tower than would otherwise be permissible.

Although not shown, the cables 20 are taut or tensioned in their attachment between the interface module 18 and the anchors 22. Once anchored, the cables 20 permit shared loading of bending moments in the tower 12. From an attachment point of the cable 20 on the interface module 18 and downward, bending moments are significantly reduced. Although not shown in FIGS. 1 and 2, the interface module 18 may be inserted between any two sections of a tower. As examples, the interface module 18 may be positioned between any two sections of a modular tower (as shown) and/or between a tower and an energy generating unit 14 (as long as the cables 20 are arranged to avoid interference with the blades 34). Further, multiple interface modules 18 may be utilized at different locations. Embodiments of the invention are not limited to the location shown in the figures. Although six cables 20 are shown in FIGS. 1 and 2, embodiments of the invention are not limited to six cables. Specifically, embodiments of the invention specifically include more than 6 cables or less than 6 cables. However, using a larger number of cables, such as 6 cables compared to 4, means that each cable may be relatively smaller, which advantageously eases transportation and handling of the cables themselves while reducing the cost of transportation and handling.

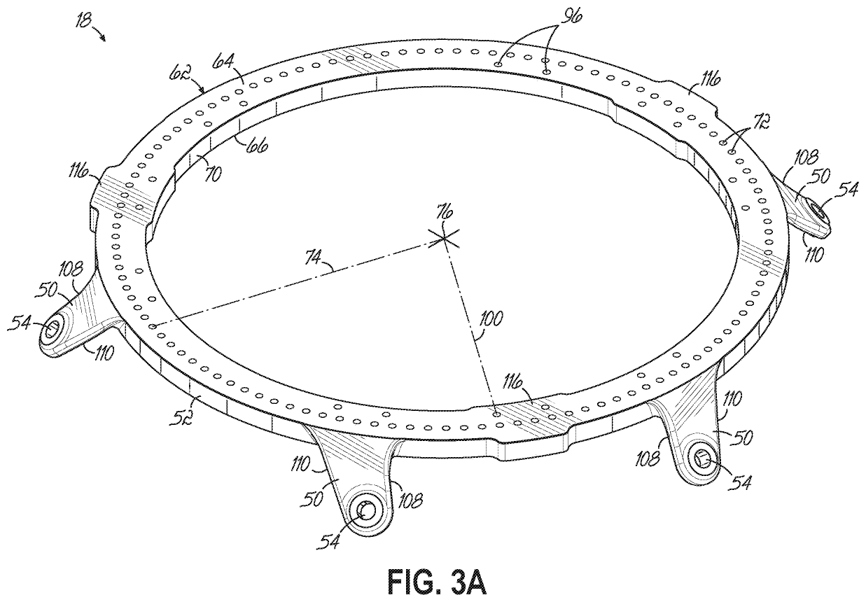

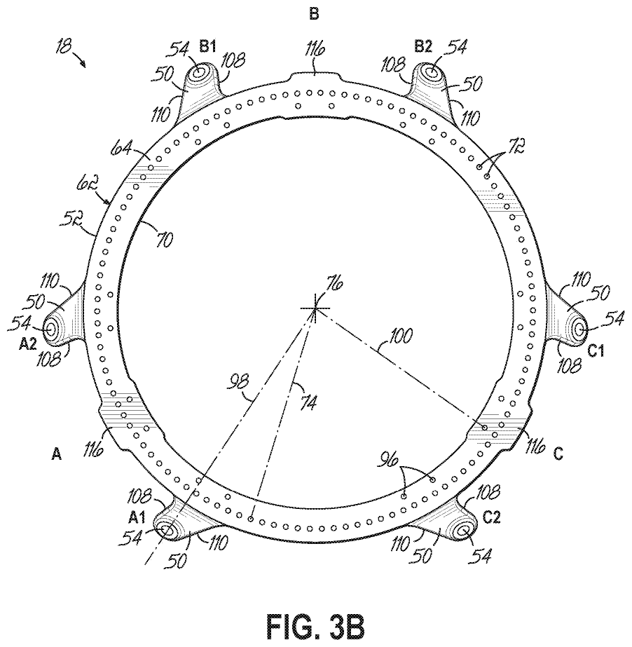

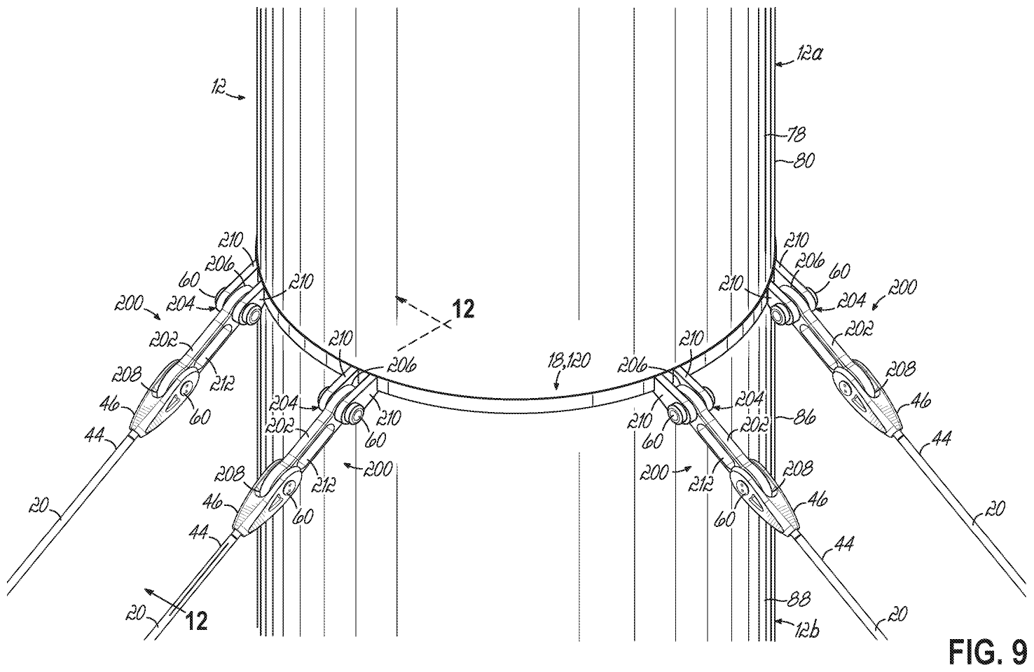

With continued reference to FIG. 2, cables 20 are coupled to the interface module 18 at joints 42 at one end 44 of each cable 20. Each cable 20 is coupled to the interface module 18 at an ear 50 that extends outwardly and downwardly from an outer surface 52 of the interface module 18. In the exemplary embodiment shown, the interface module 18 includes six ears 50. Each ear 50 includes a through-bore 54 (shown best in FIG. 3A) by which the joint 42 is made with the cable 20. To form the exemplary joint 42, an end portion 44 of each cable 20 is fitted with a socket 46. An eyelet 56 is secured between the ear 50 and the socket 46 via a pair of pins 60. The joints 42 shown in FIG. 2 are cardan-type joints with two axes of rotation. The axes are each defined by one of the pins 60 near each end of the eyelet 56. The two axes are offset from one another and oriented perpendicular to one another. However, the joints 42 are not limited to the style shown in FIG. 2. As an example, an alternative joint configuration is described below with respect to FIG. 9.

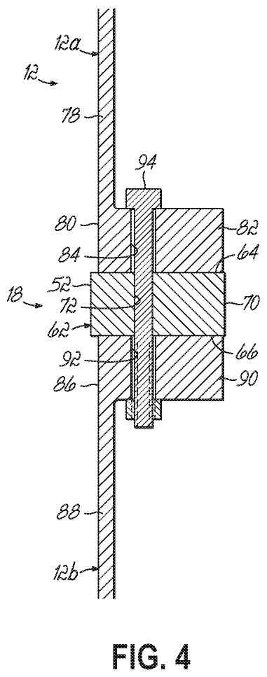

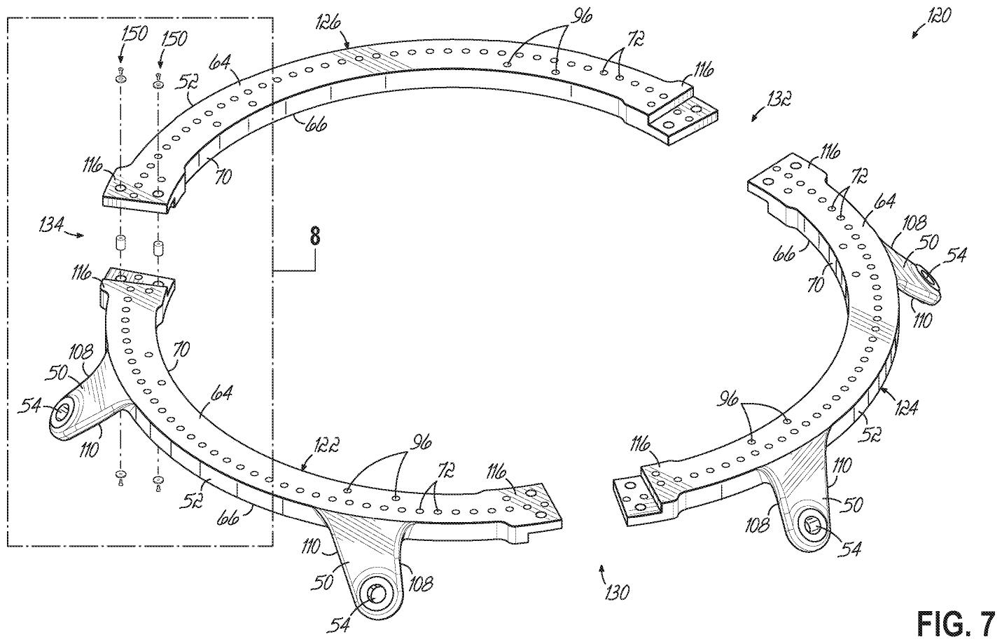

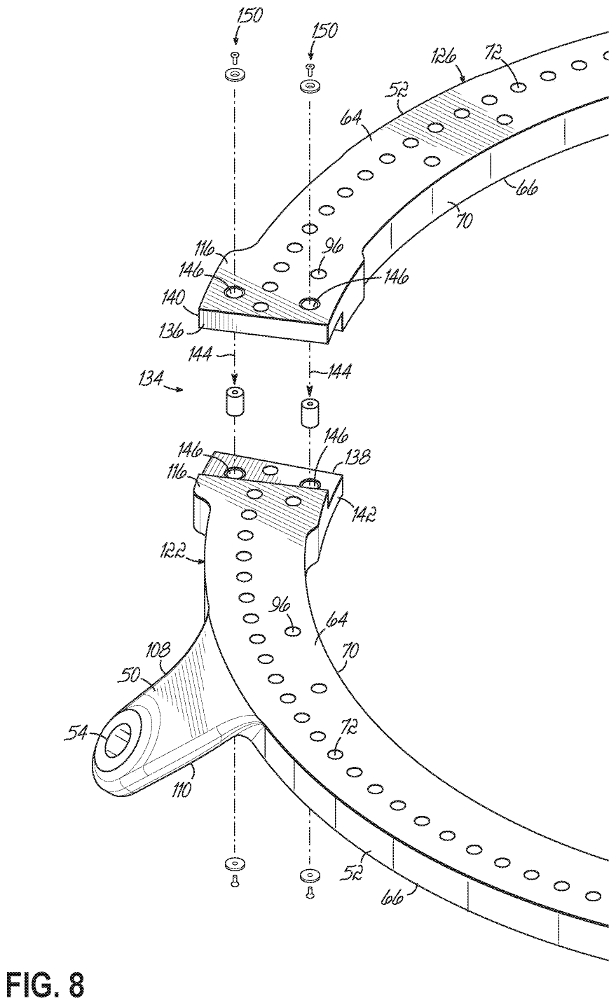

With reference to FIGS. 3A and 3B, the interface module 18 includes a continuous ring 62 (i.e., it is non-segmented) that defines the outer surface 52 and from which the ears 50 extend outwardly and downwardly. The ring 62 further includes a top surface 64, a bottom surface 66, and an inside surface 70. As shown in FIG. 4 for example, the ring 62 may have a rectangular cross section. As an alternative to the continuous ring 62, a segmented interface module is described below with reference to FIGS. 7 and 8 in which the ring 62 is a collection of smaller, separate segments that may be assembled prior to installation. Each of the interface modules described herein may be formed by casting, machining, or the like. For example, the interface module 18 shown in FIG. 3A and including the ring 62 may be a monolithic metallic structure that is cast and then machined to dimension. In FIG. 3A, a plurality of through-bores 72 extend through the continuous ring 62 and open to each of the top surface 64 and the bottom surface 66. By way of example only, the through-bores 72 may be on a first radius 74 from a central axis 76 of the interface module 18 and be between the two surfaces 52, 70. The through-bores 72 permit the interface module 18 to be secured between any two tower sections 12a, 12b, and 12c. As an example, FIGS. 2 and 4 illustrate the interface module 18 between the tower section 12a and the tower section 12b.

In the exemplary embodiment shown in FIGS. 2 and 4, the interface module 18 is secured between the tower section 12a and the tower section 12b. At end 80 (i.e., lower end) of the tower section 12a, a flange 82 extends inwardly from a tower wall 78 and includes a plurality of through-bores 84. Similarly, at end 86 (i.e., upper end) of the tower section 12b, a flange 90 extends inwardly from a tower wall 88 and includes a plurality of through-bores 92. The end 80 of the tower section 12a contacts the top surface 64 of the interface module 18, and the end 86 of the tower section 12b contacts the bottom surface 66 of the interface module 18. The through-bores 84, 72, and 92 through the flange 82, the interface module 18, and the flange 90, respectively, are aligned and each receives a bolt 94 or another type of fastener. The interface module 18 is thus secured between the two flanges 82 and 90 by the bolts 94. In the embodiment shown, with the interface module 18 sandwiched between the two tower sections 12a and 12b, the interface module 18 carries compressive loads from the weight of the tower section 12a and the energy generating unit 14 but does not distribute tensile forces between tower sections 12a and 12b because it is secured in the tower 12 in compression with bolts 94. While each of the tower sections 12a and 12b is shown with an integral flange 82, 90, embodiments of the invention are not limited to integral flanges on the tower sections 12a, 12b, or 12c. Flanges may be welded onto sections or added by other means.

As shown in FIG. 4, when secured in position with bolts 94 in aligned through-bores 72, 84, and 92, the outer surface 52 and inside surface 70 of the interface module 18 may generally align with the respective adjacent surfaces of the tower section 12a and 12b. However, embodiments of the invention are not limited to alignment of the surfaces. General alignment between the surfaces may account for a gradually reducing diameter (i.e. tapering) of the tower sections 12a and 12b. While the interface module 18, particularly the continuous ring 62 appears as a toroid with parallel outer surface 52 and inner surface 70, the interface module 18 is not limited to that configuration. In that regard, the interface module 18 may have a conical configuration in which the outer surface 52 is tapered and so is oriented in parallel relation with the outer surfaces of the adjacent tower sections 12a and 12b. Thus, the interface module 18 may provide exterior surface geometry matching between the end 80 of the tower section 12a and the end 86 of the tower section 12b.

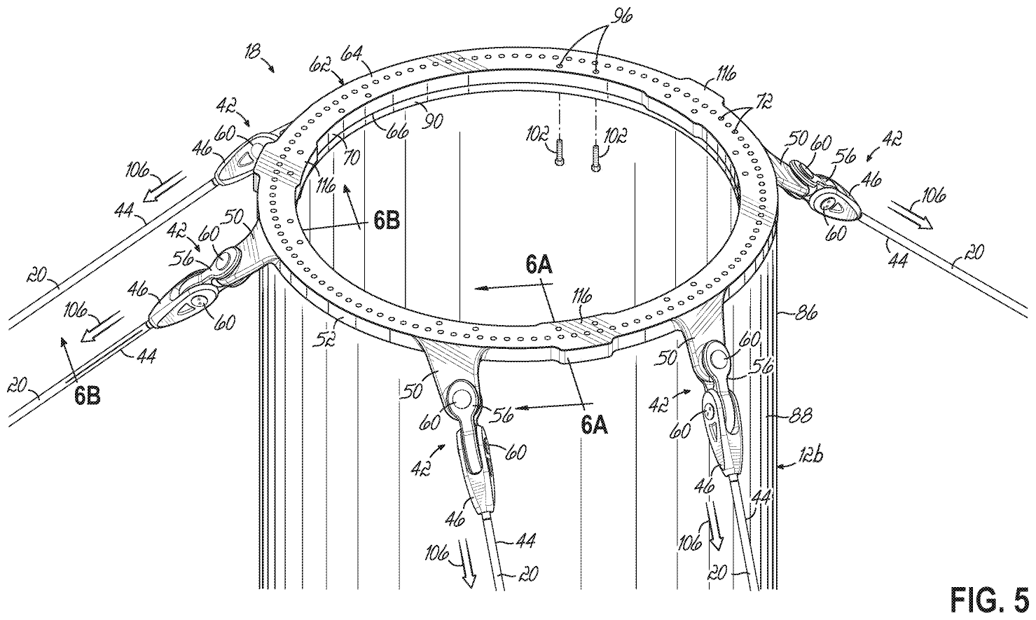

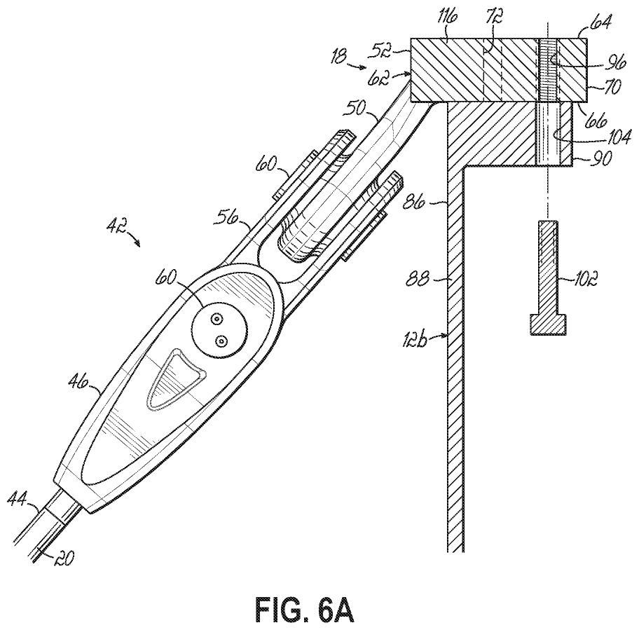

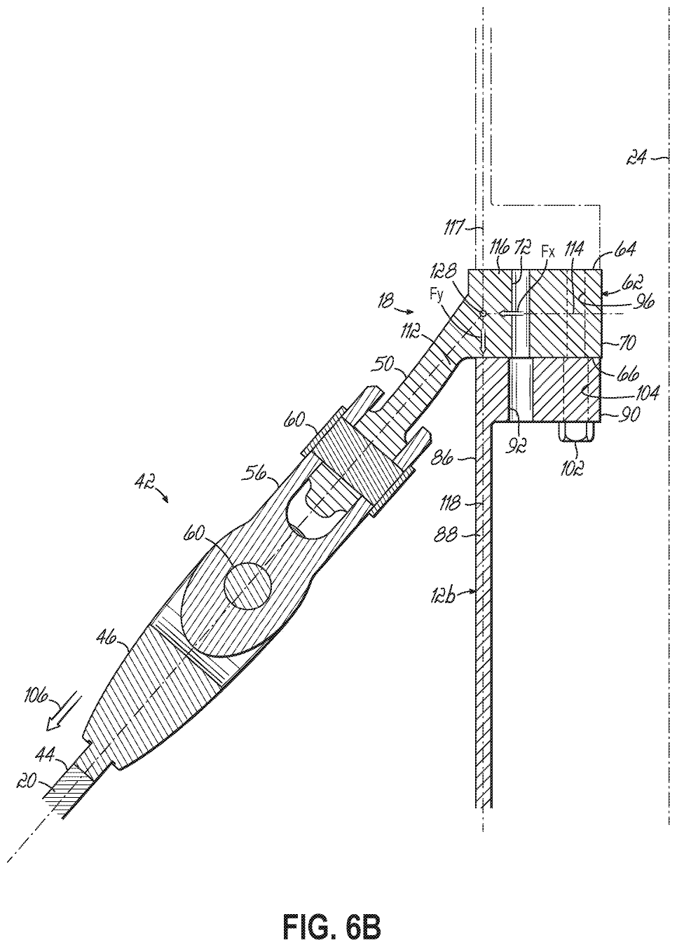

With reference once again to FIGS. 3A and 3B, in one embodiment, the interface module 18 further includes additional bores 96. While the additional bores 96 are shown as through-bores, through-bores are not required. For example, the additional bores 96 may be blind bores that open only to the bottom surface 66. The additional bores 96 are not utilized to secure the tower section 12a to the tower section 12b. In other words, the additional bores 96 may not align with any feature in the end 80 of the tower section 12a. For example, the bores 96 do not align with a through-bore in the flange 82. Instead, the bore 96 receives a fastener (e.g., a bolt, a screw, or a pin) to attach the interface module 18 to the tower section 12b, described below in conjunction with FIGS. 5-6B. In FIGS. 3A and 3B, the bores 96 are open to the top surface 64 and open to the bottom surface 66 of the continuous ring 62. The through-bores 96 do not reside on the first radius 74. In the exemplary embodiment shown, the through-bores 96 are positioned on a second radius 100. The second radius 100 is different than the first radius 74. In FIG. 3A, the second radius 100 is less than the first radius 74. As such, the through-bores 96 are generally parallel with the through-bores 72 but offset inwardly (as shown) or outwardly of the through-bores 72. In addition, the through-bores 96 may be angularly offset relative to the through-bores 72. As an example, the through-bores 96 may be positioned on a bisector between radials constructed through any two immediately adjacent through-bores 96. This arrangement is shown on opposite each ear 50. In other words, a radial taken through the central axis 76 and through a through-bore 72 does not intersect a through-bore 96 and vice versa. The cross section of FIG. 6A when compared to the cross section of FIG. 6B illustrate this offset. Further, the number of through-bores 96 may be less than the number of through-bores 72. In the exemplary embodiment, there are two through-bores 96 proximate each ear 50 and two positioned midway between pairs of ears for a total of eighteen through-bores 96 in the interface module 18.

As is best shown in FIG. 3B, in one embodiment, the ears 50 do not extend radially outward from the outer surface 52. A radial plane 98 constructed through and parallel to the central axis 76 through the bore 54 in the ear 50 does not create a symmetrical bisection of the ear 50. Pairs of ears 50 extend in similar directions as the anchor 22 of the cables 20 connected to the ears 50 may be shared by each individual pair. For example, ear A1 and ear A2 visually form a pair of ears 50 and project generally in the same direction. Other pairs include B1 and B2 and C1 and C2, such that the interface module 18 includes six ears 50 in three ear pairs (i.e., A1, A2; B1, B2; and C1, C2). Further, due to their lack of symmetry about the radial plane 98, each ear 50 includes a short side 108 and a long side 110. For a pair of ears 50, the short sides 108 of each ear 50 of the pair face one another. The long sides 110 face away from one another. For instance, in FIG. 3B, the short side 108 of ear A1 faces the short side 108 of ear A2; the short side of ear B1 faces the short side 108 of B2; and the short side 108 of ear C1 faces the short side 108 of ear C2. Also shown in FIG. 3B, the continuous ring 62 includes enlarged areas 116 in which the inside surface 70 and the outer surface 52 are spaced further apart relative to adjacent portions of the continuous ring 62 to increase the thickness of the continuous ring 62 in a localized area. The enlarged areas 116 may be positioned midway between pairs of ears. For example, enlarged area A is positioned midway between ears A1 and A2. Likewise, enlarged areas B and C are positioned midway between ears B1 and B2 and C1 and C2, respectively.

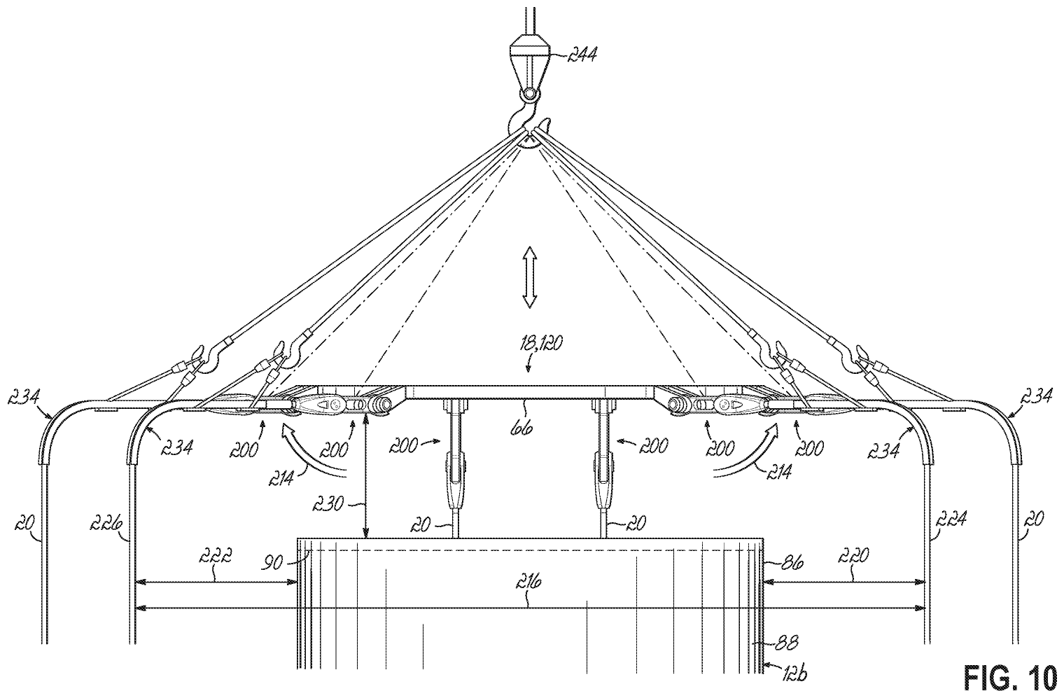

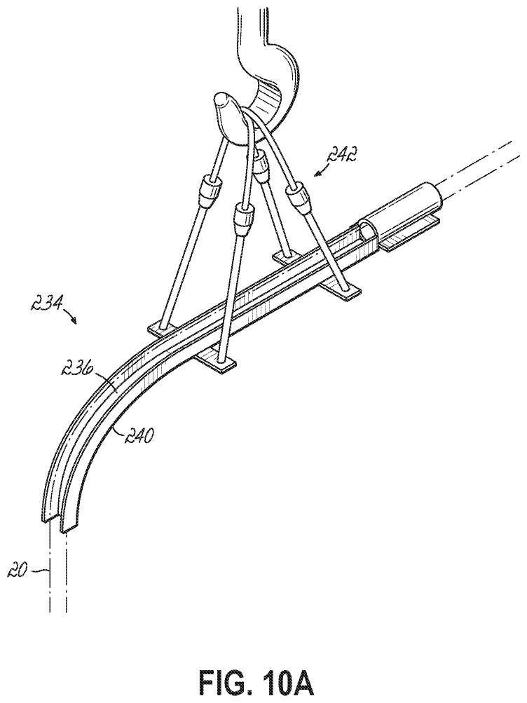

Advantageously, and with reference to FIG. 5, the interface module 18 facilitates installation of the tower 12 by permitting the cables 20 to be pretensioned while connected only to the tower section 12b. The cables 20 may be pretensioned by an amount sufficient to increase the stability of tower sections 12b and 12c prior to installation of the tower section 12a. To that end, installation of the tower 12 includes attachment of the tower section 12c to the foundation 16 (FIG. 1). The tower section 12b is hoisted into position and secured to the tower section 12c in accordance with typical installation procedures. The interface module 18 including attached cables 20 is hoisted into position onto the tower section 12b, as is shown in FIG. 5. In that regard, an exemplary method of positioning the interface module 18 on a tower section is described below with reference to FIG. 10.

With reference to FIGS. 5 and 6A, during construction of the tower 12, the interface module 18 is positioned on the tower section 12b with the bottom surface 66 of the interface module 18 in contact with the flange 90. The flange 90 includes a through-bore 104 or another feature that aligns with the additional through-bore 96 in the interface module 18. As shown in FIG. 6A, bores 96 may be threaded. Fasteners, such as bolts or screws 102, are inserted into the aligned bores 92 and 104 and are used to fasten the interface module 18 to the tower section 12b. The interface module 18 is secured only to the tower section 12b. Securing the interface module 18 to the tower section 12b occurs before the tower section 12a is positioned on the interface module 18. The cables 20, which may be carried by the interface module 18 while the interface module 18 is hoisted into position, as is shown and described below, may then be attached to anchors 22, or to another anchor point and at least partly tensioned (indicated by arrows 106 in FIG. 5) before construction of the tower 12 is completed. A tensioning device (not shown) may be utilized to increase tension in one or more cables 20. The degree of pretension on any single one of the cables 20 may be dependent on the number of fasteners 102 used to secure the interface module 18 to the tower section 12b or other factors. By way of example only, the cables may be pretensioned to at least 70% of the full, targeted tension for the wind turbine 10 when fully constructed. As an alternative, the cables 20 may be pretensioned to between 30% and 70% of the full, targeted tension for the wind turbine when fully constructed. In cases where, the cables 20 are pretensioned to an amount less than the full tension, once the tower 12 is installed, the cables 20 may be further tensioned to bring the tension from the pretensioned level to the full, targeted tension. Alternatively, further tensioning to the full, targeted tension may be achieved once the energy generating unit 14 is installed on the tower 12.

In any respect, once the cables 20 are tensioned, the tower sections 12b and 12c are more stable and thus less likely to sway or move in the wind 40 during the remainder of the construction of the wind turbine 10. Advantageously, reducing or eliminating movement of the tower sections 12b and 12c, particularly at the height of the interface module 18, permits additional tower sections, such as tower section 12a, and the energy generating unit 14 to be installed more safely and quickly due to the lack of movement. In other words, the interface module 18 is not as much of a moving target for attachment of the tower section 12a or the interface module 18 may not move at all even in some wind. While only a single interface module 18 is shown in the figures, during installation of a tower having multiple sections, an interface module 18 may be installed between each tower section or between each of multiple selected sections in accordance with embodiments of the invention. In one embodiment, once the wind turbine 10 installation is complete, the tension in one or more of the cables 20 is increased to their targeted tensile loads.

Referring to FIG. 6B, in one embodiment, the ear 50 is oriented relative to the continuous ring 62 so that bending moments do not develop in the interface module 18 from the tension in the cable 20. As shown, the ear 50 is pointed in the direction of the cable 20. The direction indicated by arrow 106 may represent a tensile force produced by the cable 20 following complete installation of the wind turbine 10. That tensile force is transferred to the tower 12 at the interface module 18 via each ear 50. As shown, the cable 20 is aligned with a neutral axis 112 of the ear 50. The ear 50 distributes forces from the cable 20 to the continuous ring 62. To do so without causing a bending moment, the neutral axis 112 intersects a neutral axis 114 of the continuous ring 62 and intersects a neutral axis 118 of the section 12b (and axis 117 of the section 12a shown in phantom) at intersection 128. With this orientation of the ear 50 relative to the continuous ring 62, principle components (labeled Fx and Fy) of a tensile force 106 are aligned with each neutral axis 112 and 114 so that bending moments do not develop in the continuous ring 62 when the cable 20 is tensioned.

Further in that regard and with reference to the joint 42, the cable 20 is oriented to be coincident with the neutral axis 112 as nearly as possible. Because the loading on the wind turbine 10 is dynamic, the tensile force in the cable 20 is also dynamic. Further, the cable 20 may move (e.g., oscillate) during operation of the wind turbine 10. The cardan-type joint 42 prevents any misalignment or movement of the cable 20 relative to the ear 50 during operation of the wind turbine 10 and prevents causing substantial bending stresses in the cable 20 at the end 44, such as at the socket 46. In this way, the cable 20 is less likely to be mechanically fatigued.

Referring now to FIGS. 7 and 8, an alternative interface module is shown. An interface module 120 differs from the interface module 18 of FIGS. 3A and 3B in that the module 120 is segmented. That is, the interface module 120 is not a monolithic metallic structure. However, the interface module 120 may be utilized in the same manner as the interface module 18 described above. In the exemplary embodiment shown, the interface module 120 has three segments 122, 124, and 126 that are assembled together to form a segmented ring that is not monolithic. While given different labels, the segments 122, 124, and 126 may be identical. Advantageously, the segments 122, 124, and 126, because they are each smaller than the assembled interface module 120, may be manufactured and shipped individually and so occupy significantly less space for shipping purposes. At the installation site for the wind turbine 10, the segments 122, 124, and 126 are more easily individually handled prior to assembly. In that regard, each segment 122, 124, and 126 are fastened together at joints 130, 132, and 134. An exemplary joint 134 is shown in FIG. 8. While not shown, each of the remaining joints 130 and 132 may have a similar or the same configuration.

In the exemplary joint 134 shown in FIG. 8, the joint 134 is formed between an end 136 of the segment 126 and an end 138 of the segment 122. The exemplary joint 134 may be characterized as a half-lap joint with a one-half thickness member 140 of the segment 126 at the end 136 overlapping a one-half thickness member 142 of the segment 122 at the end 138. Although not shown in FIG. 8, an interface between each one-half thickness member 140, 142 in the joint 134 is oriented in a plane perpendicular to the axis 24 of the tower 12. The one-half thickness members 140 and 142 are brought into an overlapping position as indicated by arrows 144. The joint 134 has the same thickness as the thickness of each of the segments 122 and 126. In this way, the top surface 64 and the bottom surface 66 of the interface module 120 are uniformly planar across each of the segments 122, 124, and 126 when assembled. Each of the one-half thickness members 140, 142 includes a pair of through bores 146 to receive respective fasteners 150, such as pins, to secure the segment 126 to the segment 122. While fasteners 150 are shown, embodiments of the invention are not limited to the use of fasteners 150. For example, the segments 122, 124, and 126 may be secured together by welding or a combination of fasteners 150 and welding. The joint 134 may be formed at an enlarged area 116 and as such the one-half thickness members 140, 142 at ends 136, 138 are generally wider than the non-joint portions of each of the segments 122, 126 which generally form the portion of each segment 122, 124, and 126 between opposing ends. Each joint 130, 132, 134 has the same thickness as the thickness of each of the segments 122, 124, and 126. In this way, the top surface 64 and the bottom surface 66 of the interface module 120 are uniformly planar across each of the segments 122, 124, and 126 when assembled.

FIG. 9 illustrates an alternative embodiment of the joint 42 shown in FIG. 2 in which the interface module 18 includes an alternative configuration of the ear 50, shown in FIG. 2. A joint 200 between the cable 20 and the interface module 18 includes a flexible arm 202 that is coupled to an ear 204 extending from the continuous ring 62 at one end 206 and to the socket 46 at the other end 208. Unlike the ear 50 (FIG. 2), the ear 204 includes a pair of flanges 210 each of which defines a bore. Although not shown in FIG. 9, the flexible arm 202 includes a through-bore near each end 206, 208. The flexible arm 202 is insertable between the pair of flanges 210, and the pin 60 couples the flexible arm 202 to the ear 204 via the bores. At the opposing end 208 of the flexible arm 202, the pin 60 couples the flexible arm 202 to the socket 46.

Unlike the joint 42 shown in FIG. 2, in the joint 200, the axes of rotation defined by pins 60 each lie in a plane that is perpendicular to the axis 24 of the tower 12 and are parallel to one another. Rotational movement of the tower 12 about the axis 24 is thus generally perpendicular to each of the axes of rotation of the joint 200. The flexible arm 202 is configured to flex in response to at least this motion. To that end, the flexible arm 202 is configured to bend in a vertical plane along its length at loads that torsion the tower 12. This capability is aided and adjusted by a through-slot 212 in the flexible arm 202. While not particularly limited as to dimension and location in the flexible arm 202, the slot 212 may reduce an effective width of the flexible arm 202 by up to 50%. By way of further example, the slot 212 may be from 5% to 50% of the width of the flexible arm 202. As with the cardan-type joint 42, the joint 200 prevents any misalignment or movement of the cable 20 relative to the ear 204 during operation of the wind turbine 10 from causing fatigue-inducing bending stresses in the cable 20 at the end 44. In this way, the cable 20 is less likely to be mechanically fatigued during operation of the wind turbine 10.

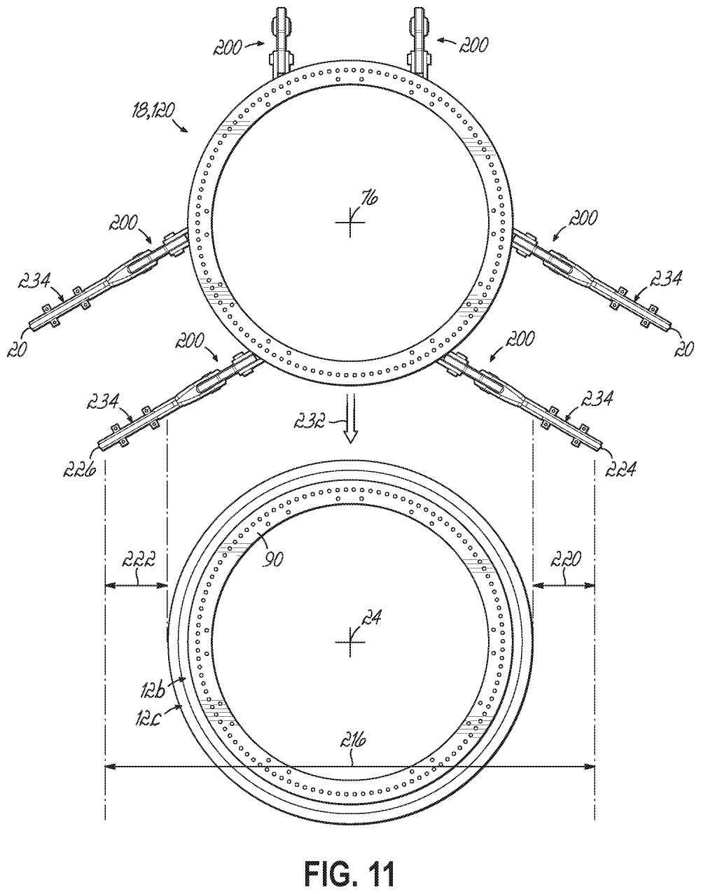

As described above, the interface module 18 is hoisted into position on the tower section 12b. As shown in FIGS. 10 and 11, during installation, the cables 20 are attached to one of the interface modules 18, 120 prior to hoisting it on to the tower sections 12b and 12c. The cables 20, which are longer than the height of the assembled tower sections 12b and 12c, hang from the interface module 18, 120 when the module 18, 120 is attached to a crane hook 244 and lifted into a position proximate the tower section 12b. If the cables 20 are left to hang from the interface module 18, their position can interfere with installation of the interface module 18, 120. To prevent interference, the cables 20 may be held in a position outwardly from the interface modules 18, 120 by one or both of two exemplary structures, described below.

One structure includes a strain-relief fixture 234. As shown in FIGS. 10 and 10A, the strain-relief fixture 234 may include an open channel 236 that defines a predetermined bend radius 240. The cable 20 lays in the channel 236, and the channel 236 prevents the cable 20 from bending by more than the predetermined bend radius 240 as the interface module 18, 120 is hoisted into position atop the section 12b. The strain-relief fixture 234 may be supported by linkage 242 that is coupled to the crane hook 244. The strain-relief fixture 234 is utilized to prevent the cable 20 from bending sharply while the interface module 18, 120 is hoisted on to the tower sections 12b, 12c by the crane hook 244. In one embodiment, of the six cables 20, four are lifted about the joint 200 (shown by arrows 214) via the strain-relief fixture 234. In this way, the strain-relief fixture 234 moves the cable 20 upwardly and away from one another to thereby create an opening through which the tower sections 12b and 12c may pass as the interface module 18, 120 is moved into position over the tower section 12b. Moving the cables 20 out of the way is also shown in FIG. 11.

In FIG. 11, selected cables 20 are moved aside from a position in which they would otherwise hang from their respective joints 200 under the influence of gravity. Moving the cables 20 from this normal hanging position widens an opening 216 to a distance that is greater than the largest diameter of the tower 12. The opening 216 may provide a clearance 220 and 222 between sides of the tower section 12b, 12c and the cables 20. For example, in the exemplary embodiment shown in FIGS. 10 and 11, the tower sections 12b and 12c are in position. When hoisting the interface module 18, 120 onto the tower section 12b, the opening 216 is at least as large as the largest diameter of the tower sections 12b and 12c. This is shown best in FIG. 11 in which the opening 216 between cables 224 and 226 is larger than the diameter of the tower sections 12b and 12c and provides clearance 220 and 222 to each side of the tower section 12b, 12c.

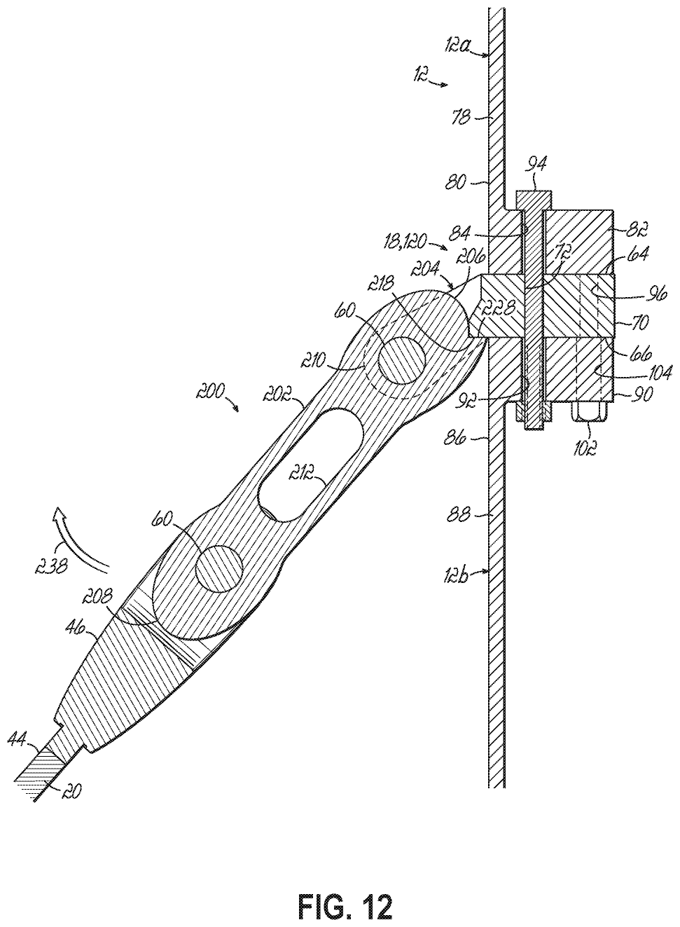

With the cables 20 in a position spaced apart from the tower sections 12b and 12c, the interface module 18, 120 need only clear the end 86 of the tower section 12b by a minimal amount 230 (FIG. 10). By way of example only, the minimal amount 230 may be from a few centimeters to half a meter. The cables 20 positioned opposite from the direction of movement (indicated by arrows 232 in FIG. 12) of the interface module 18, 120 toward the tower sections 12a, 12b may not be moved prior to installation. Attaching the cables 20 to the interface module 18, 120 prior to hoisting and separating selected cables 20 to widen an opening for the tower section 12b is advantageous. Not only does this procedure permit the installation of the interface module 18, 120 with cables 20 attached as a unit on to the tower section 12b, it also improves safety and reduces time to complete installation. Once the interface module 18, 120 is in position on the tower section 12b, the crane hook 244 may be moved downwardly to allow the cables 20 to drop toward the earth and to eventually hang directly by the respective joint 200. The controlled, gradual drop of the cables 20 may prevent them from being strained or otherwise damaged during installation.

Another mechanism by which the cables 20 may be held outwardly and so are prevented from interfering with installation of the interface module 18, 120 onto the tower 12 is shown in FIG. 12. In one embodiment of the interface module 18, 120, a lock or stop 218 extends from the outer surface 52 between flanges 210. The flexible arm 202 includes a stop 228 that is configured to contact the stop 218 on the interface module 18, 120 as the flexible arm 202 rotates about the pin 60. The placement of the stops 218, 228 permits rotation of the flexible arm 202 about the pin 60 in one direction (indicated by arrow 238) but limits rotation of the flexible arm 202 in the opposing direction. The rotational limitation provided by the stops 218, 228 are designed to maintain each of the cables 20 in an orientation that holds the cables 20 further radially outward from the interface module 18, 120 and so permits installation of the interface module 18, 120 without interference from the cables 20. As can be appreciated, if the interface module 18, 120 is lifted with the cables 20 attached, the cable 20 would hang from each ear 204 under gravity. Although not shown, the cable 20 would essentially hang straight down from the pin 60 at the end 206 of the arm 202. In this position, the spaces between hanging cables 20 would be insufficient for the tower section 12b to pass during movement of the interface module 18, 120 over the tower 12 shown in FIG. 11. However, in the presence of the stops 218, 228, the cables 20 would hang from the end 208 of the flexible arm 202.

To that end, during installation of the interface module 18, 120, the stops 218, 228 prevent the cable 20 from hanging straight down from the ear 204. The cable 20 is held outwardly by at least the length of the ear 204 and the flexible arm 202. A hanging cable 20 would then clear the tower 12b during installation by a distance related to the length of the flexible arm 202. This distance may be sufficient to maintain the opening 216 through which the tower sections 12b, 12c may pass during installation of the interface module 18, 120 toward the tower sections 12b, 12c according to arrows 232 in FIG. 11. One or both the strain-relief fixture 234 and the stops 218, 228 may be utilized during the installation of the interface module 18, 120. Although not shown, other configurations of the stops 218, 228 and additional stops are contemplated. For example, at the end 208 of the flexible arm 202, one or more additional stops may extend between the arm 202 and the socket 46 to prevent the cable 20 from hanging straight down from the flexible arm 202 at the pin 60 near end 208. This may be advantageous if additional cable clearance is desirable during installation of the interface module 18, 120. Furthermore, stops are contemplated on the cardan-type joint 42 shown in FIG. 6B, for example. Stops may be placed between the socket 46 and the eyelet 56 to provide additional clearance between the cables 20 and the tower section 12b during installation of the interface module 18 shown.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A wind turbine supported by a plurality of cables, the wind turbine comprising:
a tower fixed at one end to a foundation and comprising:
at least two tower sections, including an upper section and a lower section, each of the upper and lower sections including an inwardly directed flange having a plurality of through-bores, the flange of the lower section further including a plurality of second through-bores spaced apart from the plurality of through-bores; and
an interface module secured between the upper and lower sections and including a ring from which one or more ears extend outwardly, each ear being configured to be coupled to one of the plurality of cables, the ring) including a plurality of through-bores that align with the through-bores in the inwardly directed flanges of each of the upper and lower tower sections) and a plurality of additional bores that align with the second through-bores in the inwardly directed flange of the lower section; and
an energy generating unit being disposed on the tower and configured to produce electrical energy from wind.

2. The wind turbine of claim 1, wherein the plurality of through-bores in the ring are arranged on a first radius from a central axis of the ring and the plurality of additional bores are arranged on a second radius, wherein the second radius is larger or smaller than the first radius.

3. The wind turbine of claim 1, wherein the ring is segmented, each segment being coupled to other segments at a joint at each end.

4. The wind turbine of claim 3, wherein the ring consists of three segments, each segment including at least two ears.

5. The wind turbine of claim 1, wherein the upper and lower tower sections include a wall from which each inwardly directed flange extends, each ear extending outwardly and downwardly from the ring so that a neutral axis of the ear intersects a neutral axis of the ring at a neutral axis of each of the walls.

6. The wind turbine of claim 1, wherein each ear is coupled to a respective cable at a cardan-type joint.

7. The wind turbine of claim 6, wherein the cardan-type joint includes an eyelet and the eyelet includes a stop and wherein the cable includes a socket and the socket includes a stop that is configured to contact the stop on the eyelet to provide a limit to rotational movement of the socket when the socket rotates toward the foundation.

8. The wind turbine of claim 1, wherein each ear includes a pair of spaced-apart flanges.

9. The wind turbine of claim 8, wherein each cable is coupled to a respective ear at a joint and the joint includes two rotational axes that are each oriented in a respective plane parallel to one another while being perpendicular to a vertical tower axis.

10. The wind turbine of claim 9, wherein the two rotational axes are spaced apart by a flexible arm.

11. The wind turbine of claim 10, wherein the ring further includes a stop positioned between the flanges and the flexible arm includes a stop) that is configured to contact the stop on the ring to provide a limit to rotational movement of the flexible arm when the flexible arm rotates toward the foundation.

12. A wind turbine supported by a plurality of cables, the wind turbine comprising:
a tower fixed at one end to a foundation and comprising:
at least two tower sections, including an upper section and a lower section, each of the upper and lower sections including a wall from which an inwardly directed flange extends, each inwardly directed flange having a plurality of through-bores; and
an interface module secured between the upper and lower sections and including a ring from which one or more ears extend outwardly and downwardly from the ring so that a neutral axis of the ear intersects a neutral axis of the ring at a neutral axis of each of the walls, each ear being configured to be coupled to one of the plurality of cables, the ring including a plurality of through-bores that align with the through-bores in the inwardly directed flanges of each of the upper and lower tower sections; and
an energy generating unit being disposed on the tower and configured to produce electrical energy from wind.

13. The wind turbine of claim 12, wherein the flange of the lower section further includes a plurality of second through-bores spaced apart from the plurality of through-bores and the interface module includes a plurality of additional bores that align with the second through-bores in the inwardly directed flange of the lower section.

14. The wind turbine of claim 13, wherein the plurality of through-bores in the ring are arranged on a first radius from a central axis of the ring and the plurality of additional bores are arranged on a second radius, wherein the second radius is larger or smaller than the first radius.

15. The wind turbine of claim 12, wherein the ring is segmented, each segment being coupled to other segments at a joint at each end.

16. The wind turbine of claim 15, wherein the ring consists of three segments, each segment including at least two ears.

17. The wind turbine of claim 12, wherein each cable is coupled to a respective ear at a cardan-type joint.

18. The wind turbine of claim 17, wherein the cardan-type joint includes an eyelet and the eyelet includes a stop and wherein the cable includes a socket and the socket includes a stop that is configured to contact the stop on the eyelet to provide a limit to rotational movement of the socket when the socket rotates toward the foundation.

19. The wind turbine of claim 12, wherein each ear includes a pair of spaced-apart flanges.

20. The wind turbine of claim 19, wherein each cable is coupled to a respective ear at a joint and the joint includes two rotational axes that are each oriented in a respective plane parallel to one another while being perpendicular to a vertical tower axis.

21. The wind turbine of claim 20, wherein the two rotational axes are spaced apart by a flexible arm.

22. The wind turbine of claim 21, wherein the ring further includes a stop positioned between the flanges and the flexible arm includes a stop that is configured to contact the stop on the ring to provide a limit to rotational movement of the flexible arm when the flexible arm rotates toward the foundation

23. A method of installing a wind turbine including an energy generating unit and a wind turbine tower to be coupled to a plurality of cables, the method comprising:
installing at least one lower tower section on a foundation,
installing an interface module on the uppermost one of the at least one lower tower section, the interface module including a ring and a plurality of ears extending outwardly from the ring, each ear being configured to be coupled to one of the plurality of cables;
attaching the interface module to the uppermost one of the at least one lower tower section;
tensioning each cable between one of the plurality of ears and an anchor;
installing at least one upper tower section on the interface module; and
after tensioning, installing the energy generating unit on the wind turbine tower, wherein the uppermost one of the at least one lower tower section) includes a wall and a first flange that extends inwardly from the wall, the first flange including a plurality of through-bores and a plurality of second through-bores and the ring includes a plurality of through-bores configured to align with the through-bores of the first flange and a plurality of additional bores configured to align with the second through-bores of the first flange, and wherein attaching the interface module includes coupling the interface module to the first flange) via fasteners in the second through-bores and the additional bores.

24. The method of claim 23, wherein after attaching the interface module to the upper tower section and prior to installing the energy generating unit, the method further comprises:
installing an additional interface module on the at least one upper tower section and installing an additional upper tower section on the additional interface module, wherein the at least one upper tower section includes a wall and a second flange that extends inwardly from the wall, the second flange including a plurality of through-bores and wherein installing the at least one upper tower section includes aligning the through-bores of the second flange with the through-bores of each of the interface module and the first flange and inserting fasteners through the aligned through-bores of each of the upper tower section, the interface module, and the at least one upper tower section.

25. The method of claim 23, wherein prior to installing the interface module, the method further comprises:
attaching one or more of the plurality of cables to one or more of the plurality of ears.

26. The method of claim 25, wherein installing the interface module includes separating the attached cables to create an opening sized to allow the upper tower section and any previously installed lower tower section to pass through the opening.
